(19) United States
(12) Patent Application Publication
(10) Pub. No.: US 2013/0265711 A1
(43) Pub. Date: Oct. 10, 2013

(54) EXTERNAL HARD DRIVE

(71) Applicants: HONG FU JIN PRECISION INDUSTRY (ShenZhen) CO., LTD., (US); HON HAI PRECISION INDUSTRY CO., LTD., New Taipei (TW)

(72) Inventor: QIANG CHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/709,463

(22) Filed: Dec. 10, 2012

(30) Foreign Application Priority Data
Apr. 5, 2012 (CN) 201210097132.1

(51) Int. Cl. G11B 33/02

(52) U.S. Cl. CPC G11B 33/025
USPC 361/679.36; 361/679.33

(57) ABSTRACT

An external hard drive includes a housing and a disk drive assembly received in the housing. A first magnet is located in the housing, and the disk drive assembly includes a second magnet opposite to the first magnet. Adjacent sides of the first magnet and the second magnet have the same polarity so that the first and second magnets repel each other, and the disk drive assembly is suspended over the first magnet.

### BACKGROUND

1. Technical field

The disclosure generally relates to an external hard drive.

2. Description of the Related Art

Many external hard drives include a housing and a disk drive assembly received in the housing for storing data. Generally, the disk drive assembly is fixed in the housing with screws. However, if the housing suffers shock and impact, the disk drive assembly may be damaged.

Therefore, there is room for improvement within the art.

### BRIEF DESCRIPTION OF THE DRAWINGS

Many aspects of an exemplary external hard drive can be better understood with reference to the following drawings. The components in the drawings are not necessarily drawn to scale, the emphasis instead being placed upon clearly illustrating the principles of the exemplary external hard drive. Moreover, in the drawings, like reference numerals designate corresponding parts throughout the several views. Wherever possible, the same reference numbers are used throughout the drawings to refer to the same or like elements of an embodiment.

FIG. 1 is a partially exploded view of an external hard drive, according to an exemplary embodiment.

FIG. 2 is an assembled view of the external hard drive shown in FIG. 1.

FIG. 3 a cross-sectional view of the external hard drive along line III-III shown in FIG. 2.

### DETAILED DESCRIPTION

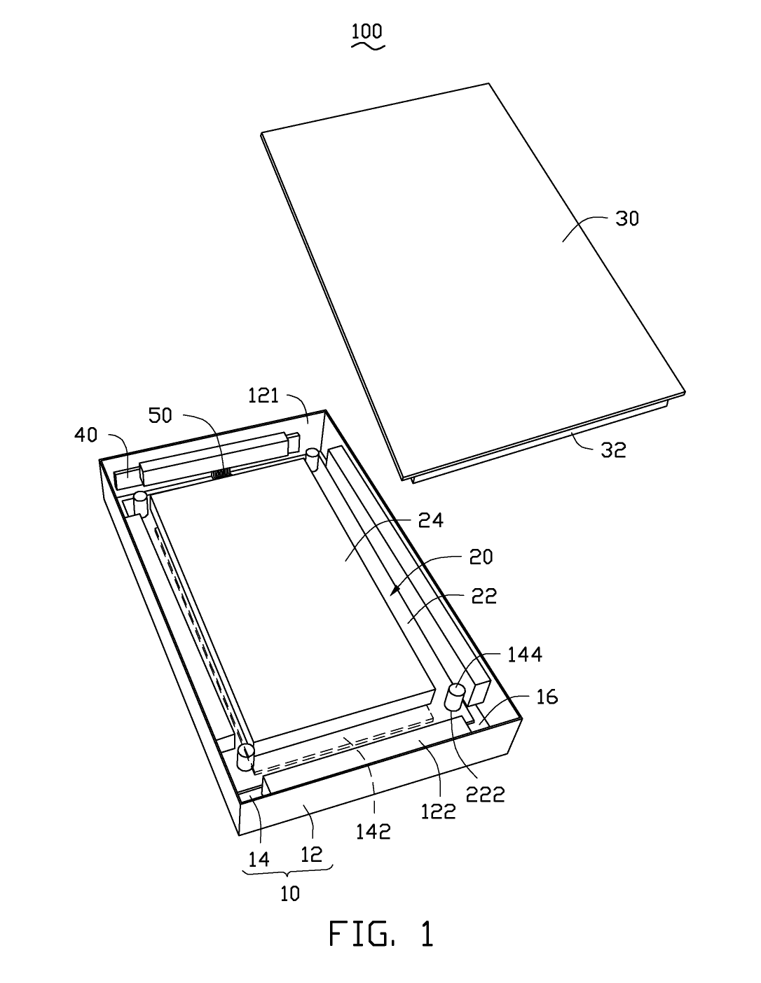

FIG. 1 is a external hard drive 100 according to an exemplary embodiment. The external hard drive 100 includes a housing 10, a disk drive assembly 20 received in the housing 10, and a cover 30 covering the housing 10.

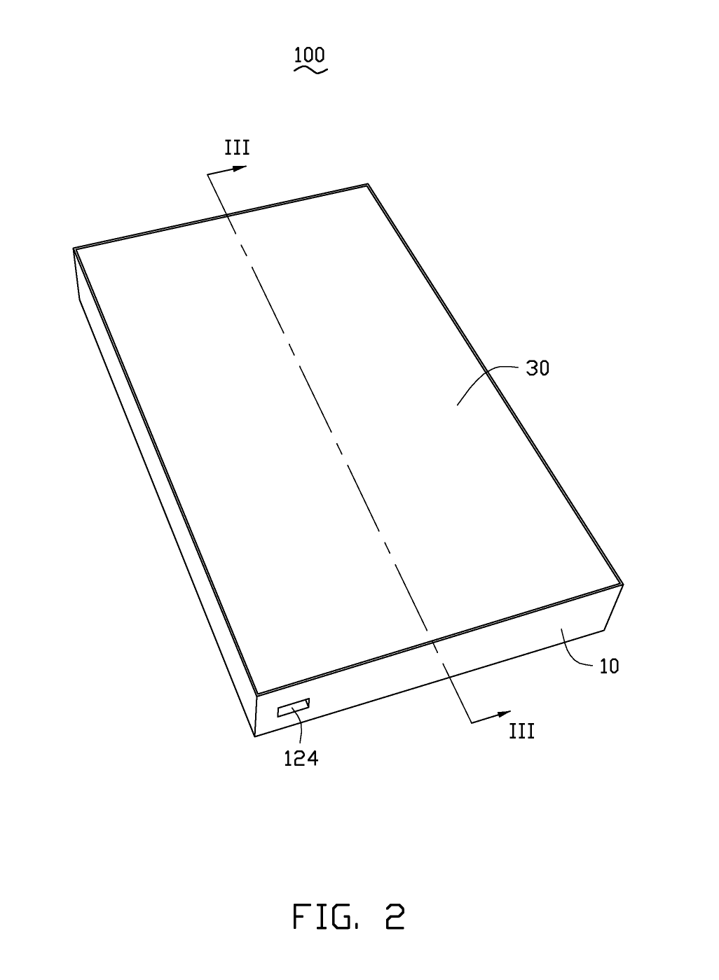

The housing 10 includes four sidewalls 12 connected with each other and a bottom wall 14. The four sidewalls 12 are perpendicularly connected to the bottom wall 14. The four sidewalls 12 and the bottom wall 14 together define a receiving cavity 16. Each sidewall 12 includes an inner surface 121, and a buffer block 122 is located on the inner surface 121 of each sidewall 12. In this exemplary embodiment, there are four buffer blocks 122. The buffer blocks 122 are made from soft sponge-like material. A circuit board 40 is located on one of the four sidewalls 12, and the circuit board 40 is electronically connected to the disk drive assembly 20 through a plurality of wires 50. Also referring to FIG. 2, the circuit board 40 includes a universal serial bus (USB) connector (not shown), and the sidewall 12 that the circuit board 40 located on defines a groove 124 for receiving the USB connector. A first magnet 142 and a plurality of guide posts 144 are located on the bottom wall 14. The plurality of guide posts 144 are configured to guide the disk drive assembly 20 during assembly process.

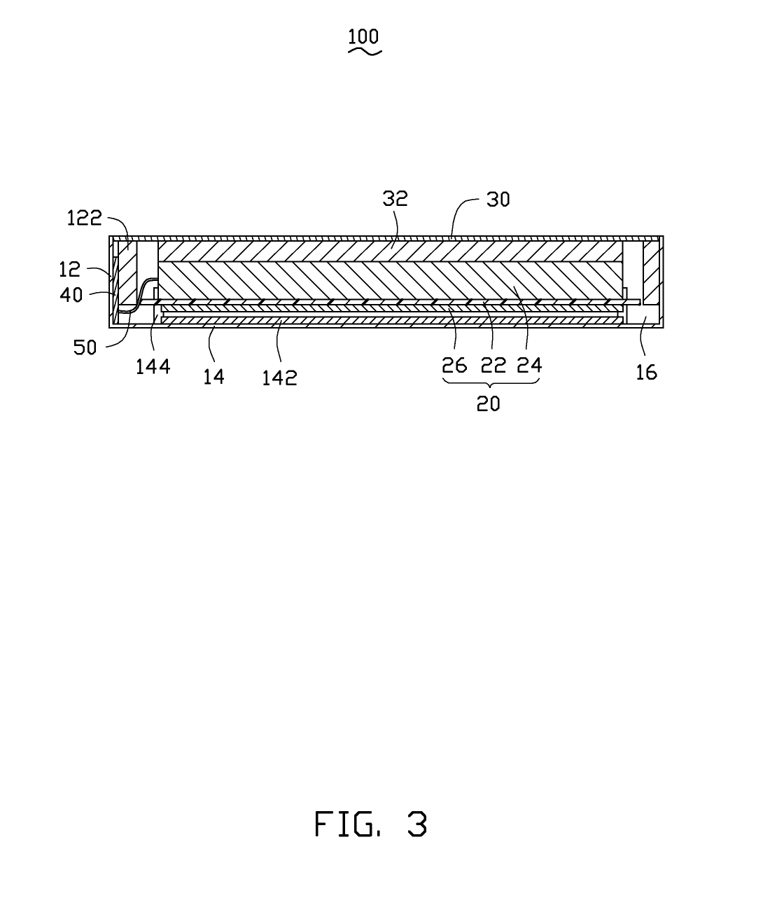

Referring to FIG. 3, the disk drive assembly 20 includes a support board 22, a disk drive 24 and a second magnet 26. The disk drive 24 and the second magnet 26 sandwich the support board 22. The support board 22 defines a plurality of through holes 222 corresponding to the plurality of guide posts 144. Adjacent sides of the second magnet 26 and the first magnet 142 have the same polarity, in other words they arranged to repel each other. A cushion 32 is located on the cover 30. In this embodiment, the cushion 32 is tabular and the size of the cushion 32 corresponds to the disk drive 24. The cushion 32 is made from soft sponge-like material.

Referring to FIG. 2 and FIG. 3, the assembly process of the external hard drive 100 may be as follows:

The second magnet 26 is located opposite to the first magnet 142. The plurality of guide posts 144 pass through the corresponding plurality of through holes 222. Because the second magnet 26 and the first magnet 142 repel each other there is space between the magnets 26, 142, and the disk drive assembly 20 is suspended over the first magnet 142. The buffer blocks 122 are around the disk drive assembly 20. The cover 30 is covered on the housing 10 to allow the cushion 32 to resist and compact the disk drive 24. The assembly process of the external hard drive 100 is completed.

The disk drive 24 is suspended in the housing 10, and thus protected if the housing 10 suffers shock and impact. The buffer blocks 122 and the cushion 32 can absorb impact forces on the housing. Therefore, the disk drive 24 is effectively protected.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. An external hard drive, comprising:
a housing; and
a disk drive assembly received in the housing;
wherein a first magnet is located in the housing, and the disk drive assembly comprises a second magnet opposite to the first magnet; adjacent sides of the first magnet and the second magnet have the same polarity and the first magnet and second magnet repel each other.

2. The external hard drive as claimed in claim 1, wherein the housing comprises a four sidewalls connected with each other and a bottom wall; the four sidewalls and the bottom wall together define a receiving cavity; the first magnet is located on the bottom wall, and the disk drive assembly is received in the receiving cavity.

3. The external hard drive as claimed in claim 2, wherein each sidewall comprises an inner surface, and a buffer block is located on the inner surface.

4. The external hard drive as claimed in claim 3, wherein the buffer block is made of sponge.

5. The external hard drive as claimed in claim 2, wherein the disk drive assembly further comprises a support board, and a disk drive; the disk drive and the second magnet are respectively located on two opposite sides of the support board.

6. The external hard drive as claimed in claim 5, wherein a plurality of guide posts configured to guide the disk drive assembly are located on the bottom wall.

7. The external hard drive as claimed in claim 6, wherein the support board defines a plurality of through holes corresponding to the plurality of guide posts; each post pass through a corresponding through hole.

8. The external hard drive as claimed in claim 3, wherein the external hard drive further comprise a cover covered on the housing, a cushion is located on the cover and resists the disk drive assembly.

9. The external hard drive as claimed in claim 8, wherein the cushion is made of sponge.

10. An external hard drive, comprising:
a housing; and
a disk drive assembly received in the housing;
wherein a first magnet is located in the housing, and the disk drive assembly comprises a second magnet opposite to the first magnet, adjacent sides of the first magnet and the second magnet have the same polarity so that the first and second magnets repel each other, and the disk drive assembly is suspended over the first magnet.

11. The external hard drive as claimed in claim 10, wherein the housing comprises a four sidewalls connected with each other and a bottom wall; the four sidewalls and the bottom wall together define a receiving cavity; the first magnet is located on the bottom wall, and the disk drive assembly is received in the receiving cavity.

12. The external hard drive as claimed in claim 11, wherein each sidewall comprises an inner surface, and a buffer block is located on the inner surface.

13. The external hard drive as claimed in claim 12, wherein the buffer block is made of sponge.

14. The external hard drive as claimed in claim 11, wherein the disk drive assembly further comprises a support board, and a disk drive; the disk drive and the second magnet are respectively located on two opposite sides of the support board.

15. The external hard drive as claimed in claim 14, wherein a plurality of guide posts configured to guide the disk drive assembly are located on the bottom wall.

16. The external hard drive as claimed in claim 15, wherein the support board defines a plurality of through holes corresponding to the plurality of guide posts; each post pass through a corresponding through hole.

17. The external hard drive as claimed in claim 12, wherein the external hard drive further comprise a cover covered on the housing, a cushion is located on the cover and resists the disk drive assembly.

18. The external hard drive as claimed in claim 17, wherein the cushion is made of sponge.
